(19) United States
(12) Patent Application Publication
(10) Pub. No.: US 2013/0079439 A1
(43) Pub. Date: Mar. 28, 2013

(54) COMPOSITE MATERIAL MADE OF A MATERIAL CONTAINING CELLULOSE AND A PLASTIC MATERIAL

(71) Applicants: Carlo Schuetz, Messel (DE); Christian Roth, Lautertal (DE); Ruediger Carloff, Darmstadt (DE); Klaus Schultes, Wiesbaden (DE); Victor Khrenov, Frankurt (DE); Eric Reinheimer, Gross-Zimmern (DE)

(72) Inventors: Carlo Schuetz, Messel (DE); Christian Roth, Lautertal (DE); Ruediger Carloff, Darmstadt (DE); Klaus Schultes, Wiesbaden (DE); Victor Khrenov, Frankurt (DE); Eric Reinheimer, Gross-Zimmern (DE)

(73) Assignee: Evonik Roehm GmbH, Darmstadt (DE)

(21) Appl. No.: 13/702,243

(22) PCT Filed: Jun. 1, 2011
(86) PCT No.: PCT/EP11/59008

§ 371 Date: Dec. 5, 2012

(30) Foreign Application Priority Data
Jul. 5, 2010 (DE) 102010030927.3

(51) Int. Cl. C08L 97/02

(52) U.S. Cl. CPC C08L 97/02
USPC 524/13

(57) ABSTRACT

The invention relates to novel composite materials which are made of at least one material containing cellulose, preferably wood, and at least one plastic material, and which have improved mechanical and weather resistance properties.

The present invention relates to novel composite materials made of at least one cellulose-containing material, preferably wood, and of at least one plastic, with improved mechanical properties and improved weathering resistance, to a process for producing these, and also to their use.

Composite materials made of at least one cellulose-containing material and of at least one plastic are currently in particular produced industrially in the form of wood-plastic composite materials, known as WPCs or wood plastic composites. For the purposes of the invention described hereinafter, the expressions “wood-plastic-composite material(s)” and “WPC(s)” are used synonymously.

Historically, materials generally used for construction and furniture were solid timber and traditional timber-based materials. WPC materials have expanded these traditional application sectors to cover significant additional possible uses, by virtue of improved shaping methods.

WPC materials involve bonding of wood particles (such as wood fragments, sawdust, wood fibers, or wood flour) to a plastics matrix. Thermoplastics generally serve as plastics matrix.

When WPCs were originally developed in North America, woods were used mainly as inexpensive filler. The costs for the wood particles are a fraction of those for the plastics used as an alternative thereto and the wood content therefore reduces materials costs in the product. Wood has a higher modulus of elasticity than the plastics used, and an optimized wood-plastic combination therefore gives better mechanical properties than the plastic alone.

Three plastics are predominant worldwide in almost all WPC materials produced commercially. In America it is primarily polyethylene (PE) that is used, but in Europe polypropylene (PP) is mainly used. In Asia, polyvinyl chloride (PVC) is very often used as WPC plastic. All three plastics are mass-produced and can therefore be obtained at relatively low cost. This commercial aspect is one of the causes for the concentration of WPC research hitherto almost exclusively on the thermoplastics mentioned.

On the other hand, there continues to be a requirement to provide longlasting coupling of natural fibers (e.g. cellulose) to polymers. In the case of the plastics mentioned, PE, PP, and PVC, decades of development have adequately solved the problem of coupling to wood fibers, by using adhesion promoters.

Current further development of WPC materials is concerned not only with optimizing processing technology but also to a very great extent with improving product properties or with properties tailored for particular intended purposes.

WPC materials are currently used mainly outdoors. Garden decking provides a major application for WPC. Here, WPC materials primarily compete with high-grade timbers from subtropical regions. WPC materials in construction applications are expected not only to provide a strong material but also to have very high durability, or at least durability comparable to that of robust natural timbers.

The starting materials used in WPC materials generally cause these to undergo alteration due to weathering effects when they are used outdoors, unless they are protected by a surface finish. The degree of aging depends firstly on the robustness of the wood fibers used, and secondly on the long-term performance of the plastic used.

It is well known that plastics have very wide ranges of properties. This applies not only to thermal properties but also to mechanical and long-term properties. Against the background of the development of durable WPC materials for the outdoor sector, there therefore continues to be a requirement for composite materials with better weathering resistance than WPCs based on polyolefins.

WPC materials are often produced by way of injection-molding processes or extrusion processes, and the production process therefore uses plastification at the melt temperature of the plastics component. Polymerization processes using solution chemistry with wood particles are also used, but less often.

Polymethyl methacrylate, abbreviated to PMMA, is known for extremely good weathering resistance and high mechanical strength values. Its property profile is therefore very suitable for construction applications. However, it has not hitherto been possible to use this material for WPC applications because processing temperatures required during the extrusion process were too high and there was resultant damage to the wood particles. The problem of coupling the PMMA to the wood particles has moreover not hitherto been satisfactorily solved.

Starting from the prior art described above, the object therefore consisted in providing composite materials made of at least one cellulose-containing material, preferably wood, and of at least one plastic, with improved weathering resistance and improved mechanical properties, and also a process for producing these.

Another object consisted in providing weathering-resistant WPC materials without additional surface finishing.

Further objects not explicitly mentioned are apparent from the entire context of the description, examples, and claims hereinafter.

The present invention is based on the concept of producing novel composite materials by using poly(alkyl)(meth)acrylate and a thermoplastic with excellent weathering resistance. The strengths of this plastic have successfully been combined with the advantages of the cellulose-containing components to give tailored composite materials.

The main task here was to achieve sufficiently good adhesion, linkage, or coupling of the cellulose-containing material, in particular natural fibers or wood fibers, to the polymer. This was achieved in that the invention uses a copolymer comprising at least one poly(alkyl)(meth)acrylate and at least one cyclic carboxylic anhydride derivative. The inventors were also successful in finding particularly suitable poly(alkyl)(meth)acrylates, and also particularly suitable additional materials.

The present invention therefore provides a composite material made of at least one cellulose-containing component, preferably wood, and of at least one plastic, characterized in that at least one plastic is composed of a copolymer comprising at least one poly(alkyl)(meth)acrylate and comprising at least one cyclic carboxylic anhydride derivative, or comprises a copolymer comprising at least one poly(alkyl)(meth)acrylate and at least one cyclic carboxylic anhydride derivative, preferably together with further polymers and/or additives and/or auxiliaries.

The present invention also provides a process in which at least one copolymer comprising at least one poly(alkyl)(meth)acrylate and at least one cyclic carboxylic anhydride derivative, optionally together with further components, is mixed with at least one cellulose-containing material and then is processed to give a composite material.

The invention equally provides the use of the composite material of the invention, in particular as material in sectors with relatively high exposure to moisture, in particular in the outdoor sector, for example as flooring, e.g. as garden decking, etc., as construction materials, for example as framing timber, boards, beams, staircases and staircase steps, posts, formwork panels, garden sheds, climbing frames, play equipment, sandpits, carports, gazebos, door frames, doors, window sills, etc., as walling elements, as wall cladding, sound-deadening elements, balustrades, as ceiling cladding, as roof covering, in shipbuilding, or for the construction of harbor facilities, e.g. landing stages, fenders, ship decks, etc., as maintenance-free furniture material in the indoor and outdoor sector, e.g. chairs, sunbeds, shelving, bar tops, garden seats, kitchen furniture, worktops, bathroom furniture, etc., as containers or edging, e.g. lawn edging, flower-bed edging, log-roll edging, flower pots, plant troughs, etc., as play blocks, and as decorative interiors for automobiles, and in the external shell of automobiles, and also as add-on components for mobile homes.

The composite material of the invention is extremely suitable for practical use outdoors, since it has low water absorption, high dimensional stability due to low swelling, and high mechanical strength.

The possibility of processing at temperatures below or equal to 225° C., preferably below or equal to 220° C., can avoid damage to the cellulose-containing material, in particular when wood is used, and can reduce energy costs.

In particular when a copolymer comprising at least one poly(alkyl)(meth)acrylate and comprising at least one cyclic carboxylic anhydride derivative is used alone or in combination with a poly(alkyl)(meth)acrylate matrix polymer, it is possible to produce a composite material which, astoundingly, can be successfully extruded with wood content of 70% by weight at about 205° C. This method can moreover even give WPCs with up to 80% by weight wood content.

The moisture performance of the extrudates of the invention is as good as or better than that of polyolefin-based WPCs.

In addition, when the plastics matrix of the invention is compared with polyolefins it has better mechanical properties and excellent weathering resistance.

Practical experiments have shown that, in comparison with the use of pure PMMA without copolymer, the use of the copolymer comprising at least one poly(alkyl)(meth)acrylate and comprising at least one cyclic carboxylic anhydride derivative can reduce water absorption from about 30% by weight to less than 5% by weight.

This is therefore the first successful attempt to produce a high-quality WPC based on poly(alkyl)(meth)acrylate.

A detailed description of the present invention now follows.

The quality of WPC materials depends greatly on compliance with various parameters: the inventors have discovered that the flow properties of the polymer are just as important as compliance with particular upper temperature limits where wood particles begin to suffer damage. It has been found that in the production of WPC materials this temperature should be below 225° C., preferably below 220° C., in order to provide substantial exclusion of carbonization of the wood particles. At said temperature the polymer should also be molten and have adequate flowability. This fact alone has hitherto been the reason for avoiding use of PMMA, since standard PMMA does not exhibit viscoelastic flow below 230° C.

Another decisive factor for the use of WPC materials is that product properties which affect performance reach minimum values or, respectively, do not exceed upper limits. Examples of these are weight increase caused by water, swelling in wet conditions, and strength values, e.g. flexural strength and breaking strength.

Materials such as wood fibers that have cellulose as main constituent are highly polar and hydrophilic. Moisture absorption, which can extend to great depths within the material, is mainly the result of the hydrophilic nature of the cellulose-containing material. The present invention is successful in achieving very good to complete “surrounding” or “sheathing” of the wood particles by the polymer, by using a copolymer comprising at least one poly(alkyl)(meth)acrylate and comprising at least one cyclic carboxylic anhydride derivative as adhesion promoter and/or matrix material. Water absorption was thus significantly reduced.

A first preferred embodiment of the present invention therefore uses at least one copolymer comprising at least one poly(alkyl)(meth)acrylate and at least one cyclic carboxylic anhydride derivative as matrix polymer and simultaneously as adhesion promoter.

A second preferred embodiment compounds a copolymer comprising at least one poly(alkyl)(meth)acrylate and at least one cyclic carboxylic anhydride derivative as adhesion promoter together with a poly(alkyl)(meth)acrylate as matrix material.

The copolymer comprising at least one poly(alkyl)(meth)acrylate and at least one cyclic carboxylic anhydride derivative can be used with random distribution of the monomer units, or else in the form of graft copolymer in which a cyclic carboxylic anhydride derivative is grafted onto a poly(alkyl)(meth)acrylate. Preferred cyclic carboxylic anhydride derivatives used are those having a 5-, 6-, or 7-membered ring, particular preference being given to use of maleic anhydride and glutaric anhydride. It can also preferably comprise further comonomers, such as styrene, α-methylstyrene, (meth)acrylic acid, and (alkyl)acrylates, (alkyl)(meth)acrylamines, (alkyl)(meth)acrylimides, N-vinylpyrrolidone, vinyl acetate, ethylene, or propylene.

“Alkyl” in the copolymer comprising at least one poly(alkyl)(meth)acrylate and comprising at least one cyclic carboxylic anhydride derivative represents a branched or unbranched, cyclic or linear alkyl moiety which has from 1 to 20, preferably from 1 to 8, particularly preferably from 1 to 4, carbon atoms and which can have substitution by functional groups or can comprise heteroatoms, such as O, S, or N. It is preferable that a methyl, ethyl, butyl, or cyclohexyl moiety is involved. It is particularly preferable to use a copolymer as disclosed as “copolymer (I)” in WO2005/108486. The contents of said document are hereby explicitly concomitantly incorporated into the description of the present application.

The definition of “alkyl” in the poly(alkyl)(meth)acrylate matrix material can be the same as that given above for the copolymer. It is particularly preferable to use polymethyl(meth)acrylate, polyethyl(meth)acrylate, or polybutyl(meth)acrylate.

The term “(meth)acrylate” represents methacrylates and also acrylates, and also mixtures of the two.

The copolymer used in the invention and comprising at least one poly(alkyl)(meth)acrylate and comprising at least one cyclic carboxylic anhydride derivative preferably involves a low-molecular-weight copolymer.

The MVR melt index [230° C., 3.8 kg] of the copolymer comprising at least one poly(alkyl)(meth)acrylate and comprising at least one cyclic carboxylic anhydride derivative is preferably in the range from 1 to 30 ml/10 min, particularly preferably from 2 to 20 ml/10 min, and very particularly preferably in the range from 3 to 15 ml/10 min.

The proportion of the entire copolymer comprising at least one poly(alkyl)(meth)acrylate and comprising at least one cyclic carboxylic anhydride derivative, based on the total weight of the composite material of the invention, is preferably in the range from 0.5% by weight to (100−proportion of cellulose-containing material) % by weight, and particularly preferably in the range from 2% by weight to ((100−proportion of cellulose-containing material)/2) % by weight.

The proportion of the cyclic carboxylic anhydride derivative in the copolymer is in turn preferably in the range from 0.1 to 5% by weight and particularly preferably in the range from 0.4 to 3% by weight, based on the total weight of the composite material of the invention.

As previously mentioned, a preferred embodiment of the present invention comprises a blend made of at least one copolymer comprising at least one poly(alkyl)(meth)acrylate and comprising at least one cyclic carboxylic anhydride derivative as adhesion promoter, and also of at least one poly(alkyl)(meth)acrylate as matrix material. Poly(alkyl)(meth)acrylate matrix material here is a matrix material which comprises exclusively poly(alkyl)(meth)acrylate as polymer component, or else a matrix material which comprises a blend of various poly(alkyl)(meth)acrylates or poly(alkyl)(meth)acrylate(s), and of other polymers, or else a matrix material which involves a copolymer of at least one poly(alkyl)(meth)acrylate and of further comonomers other than cyclic carboxylic anhydride derivatives, preferably styrene, α-methylstyrene, (meth)acrylic acid, and/or (alkyl)acrylates, (alkyl)(meth)acrylamines, (alkyl)(meth)acrylimides, N-vinylpyrrolidone, vinyl acetate, ethylene, or propylene.

The flow behavior of the poly(alkyl)(meth)acrylate matrix material has been found here to be a criterion which can be used to optimize in particular the production process. The MVR melt index [230° C., 3.8 kg] of the poly(alkyl)(meth)acrylate used as matrix material in the invention is therefore preferably in the range from 0.5 to 30 ml/10 min, particularly preferably from 1 to 20 ml/10 min, and very particularly preferably in the range from 1 to 10 ml/10 min.

Experiments with various qualities of poly(alkyl)(meth)acrylate have shown that if poly(alkyl)(meth)acrylate melts of excessively high molecular weight are used it is very difficult to achieve mixing with, for example, wood particles, since onset of damage to the wood particles was found when the necessary temperature rise was implemented. If the molecular weight of the poly(alkyl)(meth)acrylate is excessively low, problems can arise with “floating” of the wood fibers in the plastifying equipment, leading to difficulties with the mixing of the components.

The composite material of the invention also comprises a cellulose-containing component, in particular wood particles, alongside the copolymer comprising at least one poly(alkyl)(meth)acrylate and comprising at least one cyclic carboxylic anhydride derivative, and optionally alongside a poly(alkyl)(meth)acrylate matrix polymer. The proportion of the cellulose-containing component in the composite material has a major effect on the properties of the product: on the one hand, flexibility and mechanical properties are improved and an economic advantage is achieved; on the other hand, a high proportion leads to increased moisture absorption, and it is therefore difficult to realize a very high proportion of cellulose-containing component. The proportion of wood filler that can be successfully achieved with the composite material of the invention is in particular up to 80% by weight, preferably from 40 to 80% by weight, particularly preferably from 50 to 80% by weight, and very particularly preferably from 60 to 75% by weight, based in each case on the total weight of the composite material.

Cellulose-containing component used in the invention preferably involves wood or paper or paperboard, or other cellulose-containing materials. The cellulose content of the cellulose-containing component is preferably at least 20% by weight, particularly preferably at least 30% by weight, very particularly preferably at least 40% by weight. It is particularly preferable to use wood. No particular restrictions apply in relation to the wood particles in the composite materials of the invention. By way of example, wood fragments, sawdust, wood fibers or wood flour can be used.

For the purposes of the present invention, it has been found to be advantageous for the composite material to comprise a lubricant. The lubricant is important for achieving good processability of the molding composition and low processing temperatures. Particular lubricants that can be used are polyolefins, polar ester waxes, polyethylene waxes, carboxylic acids and fatty acids, and also esters of these (e.g. stearates), or else long-chain fatty alcohols and fatty alcohol esters. The proportion of the lubricant based on the total mass of the composite material, is preferably from 0 to 5% by weight, particularly preferably from 0.1 to 4% by weight, very particularly preferably from 0.5 to 4% by weight, and specifically preferably from 1 to 3% by weight.

The composite materials of the invention can comprise other conventional auxiliaries and/or additives, e.g. dyes, light stabilizers, IR absorbers, antimicrobial ingredients, flame retardants, heat stabilizers, antioxidants, crosslinking polymers, additional fiber-reinforcing additives of organic or inorganic type, polysiloxanes, polysiloxane amines, and/or polysiloxane imines.

In a particularly preferred embodiment, the composite materials of the invention comprise, in the plastic, an impact modifier, the proportion of which is in particular from 0.1 to 15% by weight, preferably from 0.5 to 10% by weight, and very particularly preferably from 1 to 6% by weight, based in each case on the mass of the plastics components present in the composite material. It is possible to use any of the commercially available impact modifiers, in particular elastomer particles with an average particle diameter of from 10 to 300 nm (measured by way of example by the ultracentrifuge method). The elastomer particles preferably have a core with a soft elastomer phase and at least one hard phase bonded thereon.

Wood-plastics composite materials which comprise up to 80% by weight of wood particles, and also at least 15% by weight of poly(alkyl)(meth)acrylate, based in each case on the total weight of the composite material have proven to be particularly advantageous, where the polymer content is composed either a) of a copolymer comprising at least one poly(alkyl)(meth)acrylate and comprising at least one cyclic carboxylic anhydride derivative or b) of a blend of at least one poly(alkyl)(meth)acrylate matrix polymer and of at least one copolymer comprising at least one poly(alkyl)(meth)acrylate and comprising at least one cyclic carboxylic anhydride derivative.

In one particularly preferred embodiment of the present invention, the composite material of the invention comprises the following components:

| | | |
|---|---|---|
| a) | cellulose-containing component, | from 40 to 80% |
| | preferably wood fibers: | by weight |
| b) | copolymer comprising at least | from 1 to 50% |
| | one poly(alkyl) (meth)acrylate | by weight |
| | and at least one cyclic | |
| | carboxylic anhydride derivative: | |
| c) | lubricant : | from 0 to 5% |
| | | by weight, |
| | | preferably from |
| | | 0.5 to 4% |
| | | by weight |
| d) | poly(alkyl) (meth)acrylate | from 0 to 59% |
| | matrix polymer: | by weight, |
| | | preferably from |
| | | 1 to 57.5% |
| | | by weight |
| e) | dye(s) | from 0 to 5% |
| | | by weight |
| f) | light stabilizers | from 0 to 0.5% |
| | | by weight, |
| | | preferably from |
| | | 0.01 to 0.2% |
| | | by weight, |

where components b) and d) together make up from 9.5% to 60% by weight of the total weight of the four abovementioned components, and the sum of the proportions of the six abovementioned components is 100% by weight. 100% by weight here is based on the total weight of the abovementioned components. This can be the same as the total weight of the composite material, but can also amount to less than 100% by weight of the composite material if the composite material also comprises components other than the abovementioned six. It is particularly preferable that the composite material of the invention comprises, as plastics, only the polymeric components b) and d), and also optionally e) and/or f), and/or at least one impact 1 modifier.

The composite material of the invention can be produced by mixing at least one copolymer comprising at least one poly(alkyl)(meth)acrylate and at least one cyclic carboxylic anhydride derivative with at least one cellulose-containing component and optionally with further components, preferably with a poly(alkyl)(meth)acrylate matrix material and/or with a lubricant, and/or with an impact modifier, and/or with any other of the abovementioned auxiliaries and/or additives, and is processed to give a composite material. Said processing preferably takes place through extrusion or injection molding. It is preferable here to plastify the material at a melt temperature below 230° C., particularly preferably below 225° C., very particularly preferably from 170 to 220° C., specifically preferably from 190 to 215° C., and very specifically preferably from 190 to 210° C.

The composite materials of the invention can be used in any of the applications known for WPCs, in particular as material in sectors with relatively high exposure to moisture, specifically in the outdoor sector, e.g. as flooring, e.g. as garden decking, etc., as construction materials, for example as framing timber, boards, beams, posts, formwork panels, garden sheds, climbing frames, play equipment, sandpits, carports, gazebos, door frames, doors, window sills, etc., as walling elements, as wall cladding, sound-deadening elements, balustrades, as ceiling cladding, as roof covering, in shipbuilding, or for the construction of harbor facilities, e.g. landing stages, fenders, ship decks, etc., as maintenance-free furniture material in the indoor and outdoor sector, e.g. chairs, sunbeds, shelving, bar tops, garden seats, kitchen furniture, worktops, bathroom furniture, etc., as containers or edging, e.g. lawn edging, flower-bed edging, log-roll edging, flower pots, plant troughs, etc.

The sound-deadening effect of the components of the invention can derive from reflection of the sound or else from absorption. For the application as sound-deadening elements with sound-absorbing effect it is preferable to produce components which are made of the composite materials of the invention and the surface of which has structuring that achieves a sound-absorbing effect, whereas for reflection smooth surfaces of the components are also adequate. It is moreover particularly preferable to use the composite materials of the invention to produce panels having hollow chambers, or profiles, where these have appropriate apertures or bores which allow the sound waves to penetrate into the component. A significant sound-absorption effect can thus be achieved. The present invention likewise covers combinations of, or modifications of, the two variants mentioned of the sound-deadening elements.

### Test Methods:

### MVR Melt Index

MVR [230° C., 3.8 kg] is determined in accordance with ISO 1133.

### Water Absorption (Boiling Test)

Water absorption is determined in a boiling test based on the EN 1087-1 standard. For this, a sample section of length 100 mm with production thickness and production width is immersed in boiling water for 5 h and after cooling for about 60 min in cold water is tested for swelling and gravimetric water absorption.

### Breaking Strength and Deflection

Breaking strength and deflection at 500 N load are determined for the composite materials of the invention by a method based on DIN EN 310 (“wood-based panels; determination of modulus of elasticity in bending and of bending strength”).

The examples below serve for further explanation of the present invention and to improve understanding thereof, but in no way restrict the invention or its scope.

### COMPARATIVE EXAMPLE 1

A PMMA molding composition of moderate molecular weight, PLEXIGLAS® FM 6N or PLEXIGLAS® FM 7N from Evonik Rohm GmbH, Darmstadt, was mixed with a proportion of 70% by weight of wood fibers and extruded. Decomposition (carbonization) of the wood particles occurred, caused by high temperature (233° C. and above) and severe adhesion on the extrusion tooling. Only very inadequate plastification of the two components could be achieved.

### COMPARATIVE EXAMPLE 2

The extrusion process as in comparative example 1 was repeated with the use of the polar ester wax LICOWAX E from Clariant, Sulzbach as lubricant. It was thus possible to keep the temperature at about 200-205° C. during the production process and to inhibit metal adhesion. Decomposition of the wood particles was avoided.

However, the disadvantage of the resultant PMMA-wood composites was that water absorption in the boiling test at 100° C. was from 20 to 40% by weight. Swelling due to moisture was therefore unsatisfactory. All dimensions (length, width, thickness) of WPC products constituted as in comparative example 2 exhibited extreme deviations from the original dimension, and the products were therefore unsuitable for outdoor use.

### INVENTIVE EXAMPLE 1

### General Description:

In the formulation of comparative example 2, poly(alkyl)methacrylate-maleic anhydride copolymer corresponding to the copolymer (I) of example A in WO 2005/108486 was added as adhesion promoter to the mixture.

Experiments showed that this type of mixture with up to 75% wood content can be plastified very successfully in the range 210° C.+/−10K and provides WPC extrudates having very low water absorption, high dimensional stability in the presence of moisture, and high mechanical stability.

### INVENTIVE EXAMPLE 1a

The experiment was carried out as in the general description. A polymethyl methacrylate-maleic anhydride copolymer corresponding to the copolymer (I) of example A in WO 2005/108486, having 10% by weight of incorporated maleic anhydride, was used as adhesion promoter.

The composition in terms of the amounts used for the extrusion process was as follows:

Wood fibers: 70% by weight
Adhesion promoter: 10% by weight
Lubricant: LICOWAX E 2.0% by weight
PMMA: PLEXIGLAS® 7N 18% by weight

The results from the performance tests on the resultant WPCs were as follows:

Water absorption in the boiling test at 100° C.: 4.3%
Breaking strength: 4114 kN
Deflection, 500N, 1.8 mm

1: A composite material, comprising:
a cellulose-comprising material and a plastic,
wherein the plastic comprises a copolymer, and
the copolymer comprises a poly(alkyl)(meth)acrylate and a cyclic carboxylic anhydride derivative.

2: The composite material of claim 1,
wherein the copolymer is an adhesion promoter, and
the poly(alkyl)(meth)acrylate is a matrix material.

3: The composite material of claim 1,
wherein the copolymer has an MVR melt index [230° C., 3.8 kg] of from 1 to 30 mL/10 min.

4: The composite material of claim 1,
wherein a proportion of the copolymer based on a total weight of the composite material, is at least 0.5% by weight and no more than a difference between 100% and a percentage proportion by weight of the cellulose-comprising material.

5: The composite material of claim 1,
wherein a proportion of the cyclic carboxylic anhydride derivative, based on a total weight of the composite material, is from 0.1 to 5% by weight.

6: The composite material of claim 1,
wherein the cellulose-comprising material comprises wood, paper, or paperboard.

7: The composite material of claim 1, comprising:
up to 80% by weight of wood particles and
at least 15% by weight of the poly(alkyl)(meth)acrylate,
based in each case on a total weight of the composite material.

8: The composite material of claim 1, consisting of:
a cellulose-containing component in a content of from 40 to 80% by weight,
the copolymer in a content of from 1 to 50% by weight,
a lubricant in a content of from 0 to 5% by weight,
a poly(alkyl)(meth)acrylate matrix polymer in a content of from 0 to 59% by weight,
a dye in a content of from 0 to 5% by weight, and
a light stabilizer in a content of from 0 to 0.5% by weight,
wherein the copolymer and the matrix polymer are together from 9.5% by weight to 60% by weight of a total weight of the composite material.

9: A process for producing a composite material, the process comprising:
processing a copolymer comprising a poly(alkyl)(meth)acrylate and a cyclic carboxylic anhydride derivative with a cellulose-comprising component, thereby obtaining the composite material.

10: The process of claim 9, further comprising:
mixing the copolymer with the cellulose-comprising component and a poly(alkyl)(meth)acrylate matrix material, a lubricant, a further additive, an auxiliary, or any combination thereof,
wherein the composite material is a wood-plastic composite material.

11: The process of claim 9,
wherein the processing comprises extruding or injection molding.

12. (canceled)

13: The composite material of claim 1, wherein the plastic further comprises an additive, an auxiliary, or any combination thereof.

14: The composite material of claim 3, wherein the MVR melt index is from 3 to 15 mL/10 min.

15: The composite material of claim 5, wherein the proportion of the cyclic carboxylic anhydride derivative is from 0.4 to 3% by weight.

16: The composite material of claim 6, wherein the cellulose-comprising material has a cellulose content of at least 20% by weight.

17: The composite material of claim 16, wherein the cellulose content is at least 30% by weight.

18: The composite material of claim 17, wherein the cellulose content is at least 40% by weight.

19: The composite material of claim 8,
wherein the cellulose-containing component consists of wood fibers,
the content of the lubricant is from 0.5 to 4%,
the content of the poly(alkyl)(meth)acrylate matrix polymer is from 1 to 57.5%, and
the content of the light stabilizer is from 0.01 to 0.2%.

20: The process of claim 11, wherein a temperature of the extruding or injection molding is below 230° C.
